(19) United States
(12) Patent Application Publication
(10) Pub. No.: US 2011/0084018 A1
(43) Pub. Date: Apr. 14, 2011

(54) RING FILTER

(75) Inventors: Jens HOPPE, ERLANGEN (DE); Markus KINSCHER, ADELSDORF (DE)

(73) Assignee: SCHAEFFLER TECHNOLOGIES GMBH & CO. KG, Herzogenaurach (DE)

(21) Appl. No.: 12/900,854

(22) Filed: Oct. 8, 2010

(30) Foreign Application Priority Data
Oct. 8, 2009 (DE) 10 2009 048 753.0

(51) Int. Cl. B01D 29/13

(52) U.S. Cl. 210/495

(57) ABSTRACT

A ring filter with a frame and a filter fabric. The frame has two axially spaced apart ring-shaped frame elements which are connected to one another by transverse struts. Between the frame elements and the transverse struts the filter fabric is arranged, and frame has two open ends which are located opposite each other in the circumferential direction.

### FIELD OF THE INVENTION

The invention relates to a ring filter with a frame and a filter fabric, wherein the frame has two axially spaced-apart ring-shaped frame elements which are connected by means of transverse struts, wherein the filter fabric is arranged between the frame elements and the transverse struts, and wherein the frame has two open ends which are situated opposite each other in the circumferential direction.

### BACKGROUND OF THE INVENTION

Ring filters of this type are used, for example, for protecting hydraulic directional valves from contamination which is found in the pressure medium flowing through the directional valve. Such a directional valve with a ring filter is known, for example from DE 100 27 080 A1. The hydraulic directional valve has an essentially cylindrically constructed valve housing in the outer circumferential surface of which are provided three annular grooves which serve as pressure medium connections. A ring filter is arranged in each of the annular grooves. The ring filters have in each case a frame from an elastic synthetic material and a filter fabric. The frame of a ring filter is composed of two ring-shaped frame elements which are arranged axially offset relative to each other extending in the circumferential direction of the ring filter, which frame elements are connected to each other by means of transverse struts. Between the frame elements and the transverse struts is arranged the filter fabric through which the pressure medium can flow to the hydraulic connections. The frame has two oppositely arranged ends which can be fastened to each other by means of a fastener. During the assembly, the ring filter is bent open, so that the ends of the frame move away from each other. This is supported by the fact that the portion of the frame located opposite the open ends is flattened at the outer circumferential surface thereof. The radial thickness of the frame elements becomes smaller continuously in the circumferential direction up to a minimum, which is located in the area of a transverse strut, and with increasing thickness after the transverse strut. Subsequently, the ring filter is placed in the annular groove of the valve housing and the fastener is closed.

Another ring filter is known from DE 90 16 138 U1 which differs from the above ring filter by the fact that instead of the flattening a recess is formed at the areas at the opposite open ends. The recess is formed at both frame elements as well as at one of the transverse struts in the form of a concave line. Consequently, the radial thickness of the frame element and the transverse strut once again is a minimum at one point of the frame.

### OBJECT OF THE INVENTION

The invention is based on the object of proposing a ring filter which has an increased service life.

### SOLUTION OF OBJECT

In accordance with the invention, the object is met by the fact that the first frame element has at least two points which are spaced apart in the circumferential direction a minimum radial thickness, wherein at these points the radial thicknesses are equal and wherein the second frame element is constructed identical to the first frame element.

The ring filter has a filter fabric which is delimited by a frame which is made, for example, of a suitable synthetic material. The frame which is usually impermeable to pressure medium holds the filter fabric in the desired shape during the flow of pressure medium therethrough. The frame has two frame elements which extend in the circumferential direction, wherein the frame elements are ring-shaped and are each arranged at an axial side surface of the ring filter. The frame elements are connected by means of transverse struts. The frame has in the area of a transverse strut two open ends which are located opposite each other in the circumferential direction. In this connection, embodiments are conceivable in which the open ends can be connected to each other. For this purpose, elements for positive engagement may be arranged at the open ends which after the assembly of the ring filter, engage with each other. Alternatively, the ends may be connected by means of an adhesive or welded connection. Also conceivable are embodiments in which the open ends are arranged spaced apart from each other after the assembly of the ring filter on the directional valve, wherein the ring filter is held in position by means of pretensioning the frame thereof.

The frame elements usually have a constant radial thickness in the circumferential direction, with the exception of a weakened area of smaller thickness. This area is usually located opposite the open ends and serves as a pretensioned “hinge: to make it possible to bend open the ring filter during the assembly, so that the open ends have a distance from each other in order to be able to place the ring filter, for example, in the annular groove of the hydraulic directional valve. The deformation takes place almost exclusively in the point of the smallest thickness, while the thicker transition areas are subject to hardly any load. In order to be able to produce the necessary distance between the open ends, the radial thickness in this weakened point of minimum radial thickness of the frame elements is to be constructed small, so that there is the danger that at this point damage may occur during assembly. During the operation of the hydraulic circuit, for example, of a crank shaft adjuster, periodical pressure variations occur which lead to a movement of the ring filter in the annular groove. These movements, in turn, stress the weakened point, so that again there is the danger of damage to the frame elements.

In accordance with the invention, it is proposed that the first frame element has a minimum radial thickness at least two points which are spaced apart from each other in the circumferential direction. At these points, the radial thicknesses are selected to be equal. In addition, the second frame element is constructed so as to be identical to the first frame element, so that the points of minimum radial thickness of the two frame elements are located axially directly opposite each other. Consequently, during the assembly of the ring filter, the ring filter is bent open at several locations. Instead of a pretensioned “hinge”, several pretensioned “hinges” are provided among which the elastic, reversible deformation is distributed. Thus, the required bending paths are smaller at the individual points than in embodiments which are known from the prior art. Therefore, these points can be constructed with greater radial thicknesses, so that the stability and the service life of the frame are significantly increased.

Since the radial thickness in the weakened point is the same, it is ensured that the bending path and, thus, the load is distributed uniformly over these points.

Consequently, the minimum radial thickness of the frame elements can be selected much greater than in the embodiments known from the prior art. Thus, the stability and the service life of the ring filter can be increased significantly.

In accordance with one concrete embodiment, it is proposed that the points of minimum radial thickness form a circular arch or several circular arches which are spaced apart in the circumferential direction of the frame elements. In this embodiment, the points of reduced thickness are combined in an angular area, so that the outer circumferential surface of each frame element has two areas. The outer circumferential surface in both areas extends along a circular arch each, wherein the radius of the circular arch of the weakened area is smaller than the radius of the other circular arch. Consequently, a plurality of points of lower but equal radial thickness is realized and, thus, the stability of the annular filter is additionally increased. Moreover, several weakened areas may be provided which are spaced apart in the circumferential direction of the annular filter, wherein the radial thickness of the weakened areas is constructed identical.

In one advantageous further development of the invention, it is proposed that the points of minimum radial thickness are arranged in the circumferential direction of the frame elements spaced apart from the transverse struts. Alternatively, it may be provided that the points of minimum radial thickness are constructed exclusively in the area of the transverse struts, wherein the thickness of the transverse struts is adapted to the thickness of the frame elements. Accordingly, it is ensured that the loads and bending angles are distributed uniformly over the points of minimum radial thickness and are not influenced by the transverse struts.

### BRIEF DESCRIPTION OF THE DRAWINGS

Additional features of the invention result from the following description and from the drawings in which an embodiment of the invention is illustrated in a simplified manner. In the drawing:

FIG. 1 shows in a top view a hydraulic directional valve with a ring filter according to the invention;

FIG. 2 is a perspective view of the ring filter of FIG. 1.

### DETAILED DESCRIPTION OF THE DRAWINGS

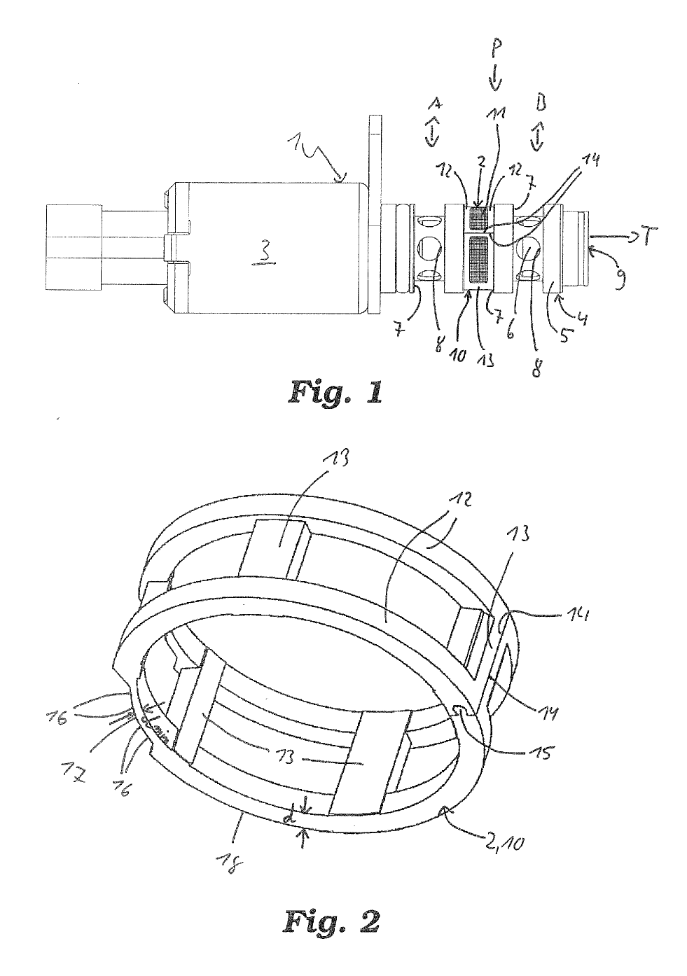

FIG. 1 shows in a top view a hydraulic directional valve 1 with a ring filter 2 according to the invention shown in the example of a directional valve 1 constructed as a four/three way proportional valve. The directional valve 1 is composed of an adjusting element 3 and a valve section 4. Such directional valves 1 are used, for example, for controlling hydraulic crank shaft adjusters or hydraulic valve controls.

The valve section 4 has an essentially cylindrically constructed valve housing 5 and a control piston 6. At the outer surface area of the valve housing 5 are arranged several annular grooves 7, wherein the annular grooves 7 are constructed so as to open radially outwardly. The annular grooves 7 are in communication through bores 8 provided in the groove bottoms to the interior of the essentially hollow cylindrically constructed valve housing 5. The bores 8 of the annular grooves 7 and the opening 9 of the valve housing 4 facing away from the electromagnetic adjusting unit 3 serve as pressure medium connections A, B, P, T.

The control piston 6 is arranged so as to be axially slidable within the valve housing 5. Adjacent pressure medium connections A, B, P, T can be connected to each other by a suitable axial positioning of the control piston 6 relative to the valve housing 5.

Arranged within the middle annular groove 7 is the ring filter 2 which extends along the entire circumference of the annular groove 7. The ring filter 2, which is shown in FIG. 2 on a larger scale, has a frame 10 and a filter fabric 11 which is only shown in FIG. 1. The frame 10 includes 2 ring-shaped frame elements 12 which extend in teh circumferential direction of the valve housing 5 and are connected to one another by means of axially extending transverse struts 13. The filter fabric 11 is arranged between the frame elements 12 and the transverse struts 13. A pressure medium, which is conveyed by a pressure medium pump, not shown, to the middle annular groove 7, reaches through the filter fabric 11 to its bores 8 and, thus, into the interior of the directional valve 1, while foreign bodies contained in the pressure medium are kept away from the interior of the directional valve 1.

The frame 10 of the ring filter 2 is not constructed so as to be closed in itself, but rather has two open ends 14 which are located opposite each other in the circumferential direction and can be connected to each other by means of positive engagement means 15. During the assembly of the ring filter 2, the elastic frame 10 in the annular groove 7 is bent open, so that the distance between the open ends 14 is enlarged. Subsequently, the ring filter 2 is placed in the annular groove 7 and the open ends 14 are connected to each other by means of the positive engagement means 15.

The frame elements 12 have a constant radial thickness d in the circumferential direction. Only in an area which is located opposite the open ends 14 in the radial direction, the radial thickness dₘᵢₙ deviates from the rest of the frame elements 12. In this area, the radial thickness dₘᵢₙ of the frame elements 12 is constructed smaller at points 16 which are spaced apart from each other in the circumferential direction. The radial thickness dₘᵢₙ of the frame elements 12 is in each of these points 16 constructed with the identical size. Simultaneously, the radial thickness dₘᵢₙ is constructed smaller in these points than at any other point of the frame elements 12. In the illustrated embodiment, the points 16 are located in an area which describes a circular arch 17 whose radius is smaller than the radius of the circular arch 18 which is defined by the rest of the frame elements 12. The areas of minimum radial thickness dₘᵢₙ at both frame elements 12 are constructed identical, i.e., the extension and the position in circumferential direction are identical. Consequently, these areas are located directly opposite each other in the axial direction. Moreover, the areas are constructed between two transverse struts 13.

When the ring filter 2 is bent open, this takes place exclusively at the points 16 having the minimum radial thickness dₘᵢₙ and, thus, in the area which describes the circular arch 17 with a smaller radius. Since the radial thickness dₘᵢₙ is the same over the entire area, the tension produced by bending is distributed uniformly over the entire area. Consequently, in contrast to the filters 2 described in the prior art, no tension peaks occur at a single point. Moreover, the minimum radial thickness dₘᵢₙ can be selected greater than in the ring filters 2 described in the prior art because the deformation is distributed over several points 16 of the frame elements 12. Consequently, the stability of the ring filter 2 is increased, while simultaneously the load acting on the points 16 having minimum radial thickness dₘᵢₙ is lowered. The arrangement of the points 16 between the transverse struts 13 ensures that the tension is distributed uniformly. Alternatively, the points 16 can be arranged exclusively in the areas of the transverse struts 13, wherein the radial thicknesses of the transverse struts 13 in the area of the points 16 having minimum thickness dₘᵢₙ also have this thickness dₘᵢₙ. Furthermore, it is also possible to arrange several areas of minimum radial thickness dₘᵢₙ at a frame element 12, wherein the areas are arranged spaced apart from each other in the circumferential direction.

### REFERENCE NUMERALS

1 Directional valve
2 Ring filter
3 Adjusting element
4 Valve section
5 Valve housing
6 Control piston
7 Annular groove
8 Bore
9 Opening
10 Frame
11 Filter fabric
12 Frame element
13 Transverse strut
14 Open end
15 Positive engagement means
16 Point
17 Arch
18 Arch
d Radial thickness
dₘᵢₙ Minimal radial thickness
A First work connection
B Second work connection
P Influx connection
T Drainage connection

1. A ring filter, comprising:
a frame; and a filter fabric,
wherein the frame has two axially spaced apart ring-shaped frame elements, a first frame element and a second frame element, which are connected to each other by means of transverse struts,
wherein the filter fabric is arranged between the frame elements and the transverse struts,
wherein the frame has two open ends which are located opposite each other in a circumferential direction,
wherein the first frame element has at least at two points which are spaced apart from each other in the circumferential direction, a minimum radial thickness,
wherein at the points the radial thicknesses are the same and
wherein the second frame element is constructed identical to the first frame element.

2. The ring filter according to claim 1, wherein the points having a minimum thickness define a circular arch or several arches spaced apart in the circumferential direction of the frame elements.

3. The ring filter according to claim 1, wherein the points of minimum radial thickness are spaced apart from the transverse struts in the circumferential direction of the frame elements.

4. The ring filter according to claim 1, wherein the points of minimum radial thickness are constructed exclusively in an area of the transverse struts, and wherein a thickness of the transverse struts is adapted to a thickness of the frame elements.
